(19) United States
(12) Patent Application Publication
(10) Pub. No.: US 2007/0045289 A1
(43) Pub. Date: Mar. 1, 2007

(54) Portable spray system

(76) Inventors: John Kott, Foothill Ranch, CA (US); Kenneth Kott, Foothill Ranch, CA (US)

Correspondence Address: STETINA BRUNDA GARRED & BRUCKER, 75 ENTERPRISE, SUITE 250, ALISO VIEJO, CA, 92656, US

(21) Appl. No.: 11/497,142

(22) Filed: Aug. 1, 2006

Related U.S. Application Data
(60) Provisional application No. 60/704,868, filed on Aug. 2, 2005.

(51) Int. Cl. H05B 3/16

(52) U.S. Cl. 219/543

(57) ABSTRACT

A portable cart is provided for spraying viscous coating material. The cart holds a resin container and an activator container, each of which is separately heated by conduction. Material transfer lines run from the containers to a spray gun, and the lines are heated. A gas tank and pressure regulator provide compressed gas to the spray gun for spraying the coating material. The spray gun is a positive displacement gun. A direct current, double stack, low-ramp motor drives two material transfer pumps to force the resin and activator through the lines to the spray gun. The two pumps are each driven through a separate helicoidal gear box. A single 110 volt AC input provides the power for the entire cart.

### CROSS-REFERENCE TO RELATED APPLICATION

This application claims the benefit of U.S. Provisional Application No. 60/704,868 filed Aug. 2, 2005, the entire content of which is hereby incorporated by reference.

### BACKGROUND

This invention relates to a method and apparatus for spraying thick, viscous materials.

Thick, viscous coating materials are sprayed onto building walls, truck beds, and other items to provide a thick elastomeric coating. The sprayed material is often a plural component urethane/polyurea material. But typical spraying equipment requires a large source of air and high air pressure. Typical applications require minimum of 7 to 11 CFM at 250-3000 psi. this typically requires the use of a very large and heavy 220 volt air compressor usually weighing hundreds of pounds. Further, the performance of the material is very sensitive to temperature, so either large, heated rooms are typically needed in order to maintain the temperature of the materials at an operating temperature, or else high temperature heat sources are needed with smaller, enclosed areas.

One portable method and apparatus for spraying truck bed liners are described in U.S. Pat. No. 6,533,189. These methods and apparatus combine two different materials in a spray nozzle with the mixture setting after it is sprayed. The containers for the materials are heated to make the materials flowable, and the spray lines are also heated to maintain the material in a flowable condition. Forcing these thick materials through the spray lines and spray nozzle takes a lot of force, and as a result these spray systems require large pumps, large air compressors, large heaters, and consume large amounts of electrical power. All current portable spray systems are believed to run on 220 volt power sources. The requirement for a 220 outlet limits the use of these sprayers, and requires long and very heavy extension cords. There is thus a need for a method and apparatus that can spray these thick materials using normal outlets of 110 volts.

### BRIEF SUMMARY

A portable spray system is provided having two heated containers of material in fluid communication with a heated spray line and a sprayer. A low ramp, double stack DC motor, optionally using a square wave power profile is used to help keep the power requirements down to where a single 110 v power supply can power the system. The motor powers two pumps having hollow shafts and helicoids gears to increase power transmission efficiency and reduce power requirements. The pumps move the coating materials through the material lines to the spray gun. Pre-pressurized air sources, such as air or nitrogen tanks provide pressurized gas to operate the spray gun. The spray gun uses mechanical plunger or other mechanical mechanisms to mix and spray the coating materials. But a low power, low pressure and low volume compressor can optionally be used instead of the pressurized gas tanks. The material lines are wrapped with low power heaters to maintain the materials at a desirable operating temperature, while reducing power requirements. The tanks holding the materials are optionally provided with individual, temperature controlled heaters, preferably low power resistance heaters.

The sprayer can fit into a portable cart sufficiently small that a single person can move the cart, and the cart can fit into an elevator. The entire spraying system can run off of a single 110 volt standard power outlet. That is a significant advantage over the current systems that typically use 220 volt outlets, or that claim to operate on a 110 volt line but in fact require multiple 110 volt connections in order to work properly.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a spray system;

FIG. 2 is a schematic view of components used in the spray system of FIG. 1;

FIG. 3 is a plan view of an electrical control panel used in the spray system of FIG. 1;

FIG. 4 is a plan view of a pressure control panel used in the spray system of FIG. 1;

FIG. 5 is a schematic view of a pumping arrangement used in the spray system of FIG. 1;

### DETAILED DESCRIPTION

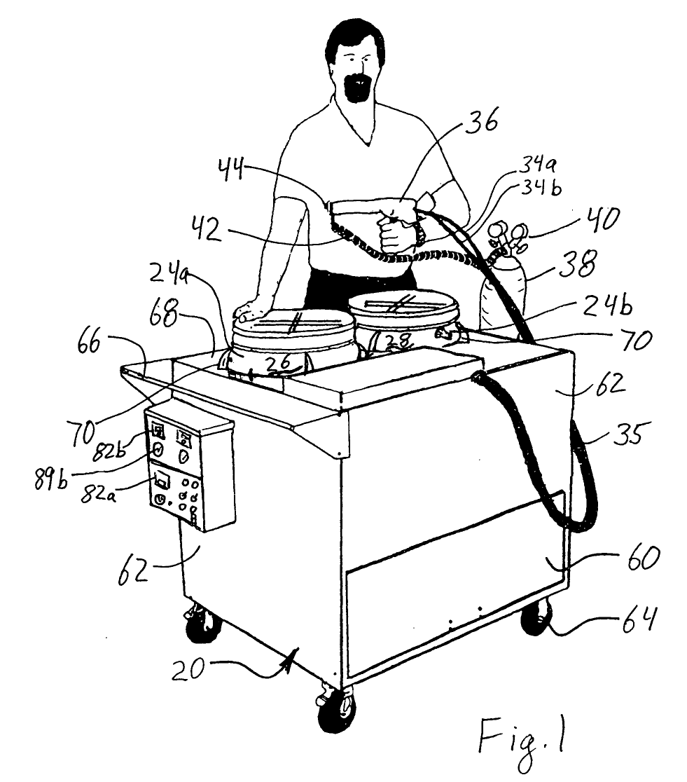

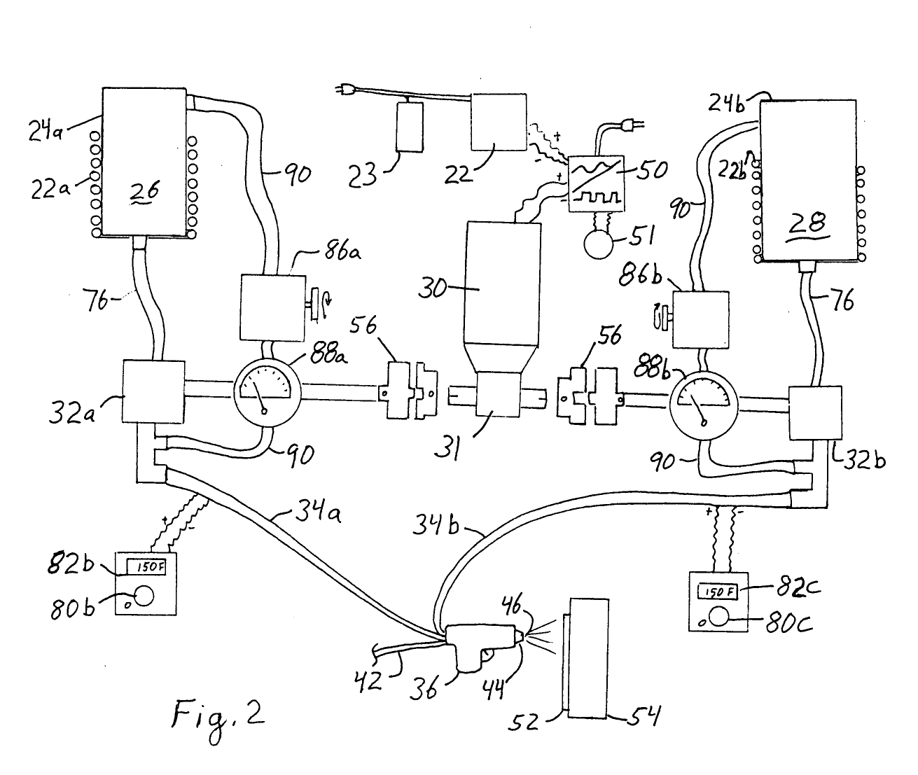

Referring to FIGS. 1-2, a portable spray system is provided that has a portable cart 20 having a temperature controlled interior provided by an auxiliary heater 22 with an adjustable thermostat 23. One or more, and typically two tanks 24 are mounted to the cart so the temperature of plural coating components can be maintained by the heater 22. There are preferably at least two tanks 24 containing plural materials for spraying. Preferably one containers 26 contains a colored resin, and one container contains an activator 28. A single motor 30 drives appropriate pumps 32 through gear drives 31 to pump the materials 26, 28 through separate material lines 34a, 34b that are connected to a spray gun 36. A resistance heater 35 is wound around at least a portion, and preferably all of the material lines 34 to keep the resin 26 and activator 28 in the lines in a flowable condition. The cart preferably carries at least one gas tank 38, such as an air bottle or nitrogen bottle, with pressure and flow regulators 40 connected air line 42. The air line 42 is also connected to the spray gun 36. The spray gun has a mixing tube that mixes the plural materials 26, 28 and provides them to a spray nozzle 44 which is in fluid communication with an outlet 46 (FIG. 2) through which the mixed materials 26, 28 are forced at a rate controlled by an operator. The pressurized air from the air line 42 is also in fluid communication with the spray nozzle 44 and exits through openings or outlets in a portion of the spray nozzle 44 to mix with the mixed materials 26, 28 and spray them onto a desired surface where the mixed materials 26, 28 harden to form a protective layer 52 on an object 54.

The cart 20 is advantageously a metal framed cart, preferably of steel. But other materials can be used. The cart 20 is preferably enclosed, with access doors 60 provided where and as needed to allow access to the interior and the components mounted in the cart. The location of the components will vary, as will the number, size and location of the access doors 60. The cart is also preferably insulated in order to help maintain the resin 26 and activator 28 at desired temperatures and to maintain an even temperature within the interior of the cart. All surfaces of the cart 20 are preferably insulated, but it is believed suitable to insulate only the four, vertical sides 62 of the cart. A ½′ thick, expanded polystyrene foam is believed suitable for the preferred embodiment. To increase portability, the cart 20 preferably has wheels 64 and a handle 66 to push and position the cart. A rectangular cart with four wheels is believed suitable. A cart about 3 feet high, three fee long, and three feet wide is believed suitable, not counting the height of wheels 64

The top 68 of the cart 20 preferably has openings into which the tanks 24 are placed. The openings are sized and shaped to conform to the cross-section of the tanks 24. The tanks 24 advantageously have one or more projections or rims 70 extending therefrom which are larger than the openings in the cart and which prevent the tanks from sliding entirely into the tank. If desired, one or more or all of the tanks 24 could be entirely enclosed within cart 20. But the two tanks 24 are preferably accessible from the exterior of the cart for refilling and for checking the level of material within the tanks.

Preferably a major portion of the tanks 24 is internal to the cart in order to maintain the temperature of the tanks and materials in the tanks. By major portion is meant a sufficient portion to allow the temperature to be maintained, and that typically requires over half of that portion of the tank that contains coating materials 26, 28 to be inside the cart 20. Two, 10 gallon tanks with locking, screw on lids that are sealed with a ½′ rubber gasket are believed suitable for the preferred embodiment. The tanks 24 are preferably sealed from atmospheric air in order to avoid deleterious effects on the materials 26, 28 that can be caused by the moisture in the atmospheric air.

The tanks 24 are preferably of polyethylene or stainless steel with a hinged lid, with the projections 70 integrally molded with the tanks when the tanks are formed. The tanks 24 can be refilled through the removable lid 72, or one or more of the tanks 24 can be physically removed from the cart 20 when empty and replaced with a full tank.

The tanks 24 contain the materials to be sprayed to form the protective layer 52. For spraying, these materials need to be heated and maintained at an operating temperature range between about 70° F. and 125° F., and more preferably up to 150° F. In order to help maintain this operating temperature, the heater 22 is provided. A 110V resistance or radiant space heater could be used. But preferably each tank 24a, 24b has a separate heater, such as a resistance heater 22a, wrapped around a portion or all of the tank 24. A separate heater 22a, 22b allows rapid heating, and lower power consumption. The resistance heaters are operable on a 110V line.

The heaters 22, 22a, 22b advantageously each have an adjustable thermostat that can be set to maintain the temperature, with only thermostat 23 for the auxiliary heater 22 being shown. The auxiliary heater 22 is preferably operated during the night mode, when the spray system is not being used. Advantageously, but optionally, the auxiliary heater 22 runs off a separate 110 volt line than does the remainder of the devices in the cart 20. During operation, the tank heaters 22a, 22b run off a 110 V power source can also optionally provide power to the auxiliary heater 22. During prolonged non-operating periods, like overnight or over the weekends, the auxiliary heater 22 can be used to maintain the minimum temperature of the tanks 24 inside the cart, and the material lines 34 stored inside the cart. Because the spray system is not in operation during these prolonged periods, it is advantageous, but optional, to have the auxiliary heater run off the 110 volt line and provide no power to the drive inverter 50.

Advantageously, the temperature is controlled to maintain the temperature of the resin 26 and activator 28 at a minimum temperature of 72° F. or 5° above ambient, whichever is greater. The resin 26 is typically a blend of polyurethane and polyurea, and is usually colored. Activator 28 is typically isocyanate. Both the resin and activator are moisture sensitive, and are preferably used when they are above about 72° F. Depending on the use of the system, other compounds can be used, and more than two tanks 24 and various coating material components can be used. The combination of auxiliary heater 22, and/or individual heaters 22a, 22b are selected to maintain the desired temperatures of the material lines 34a, 34b during storage, and to maintain the temperature of the tanks 24a, 24b during operation, but selected to maintain that desired temperature at sufficiently low power requirements that the system can operate on 110 V.

Referring to FIGS. 2-4, a variable temperature heater 22, 22a controlled by a thermostat can be used to control the temperature of the tanks 24, and/or the material lines 34. A typical operating temperature for the materials 26, 28 is about 110° F. for use in the illustrated embodiment for spraying truck bed liners. The material lines 34 are preferably maintained at a higher temperature than the tanks 24, with a temperature of about 150° F. believed suitable for the illustrated embodiment for spraying truck bed liners. But the temperature of the tanks 24 and material lines 34 can vary.

Advantageously the heater and temperature controls are on a separate panel or sub-panel so they can be grouped together. Preferably, but optionally, an on-off switch 78a can activate the heater(s) 22, 22a for the resin 26 and activator 28 in tanks 24a, 24b and switch them between a day, operational spraying mode and a night, non-operational-temporary-storage mode in which maintains a preset temperature on the tanks 24 and inside the cart 20 so the material in the lines 24 maintains a desired temperature above ambient for non-use periods. A separate switch 78b is preferably, but optionally provided to activate and deactivate the line heater 35. Preferably, but optionally, a separate temperature control 80a, 80b, 80c is provided for the tanks 24, and material lines 34a, 34b, respectively. Indicator lights can be provided to visually indicate the heaters are activated. An optional master on/off switch can be provided as desired, as can a timer reset button. The electrical connection of these controls is believed known or discernable within the skill in the art, and is not described in detail herein.

Preferably, but optionally, a temperature gauge 82a, 82b and 82c are provided for the tanks 24, and material line 34a, 34b, respectively. While a single temperature control 80a and temperature gauge 82a are shown for both tanks 24a, 24b, a separate temperature gauge and temperature control could be provided for each tank 24. Likewise, while separate controls and gauges 80b, 80c, 82b, 82c are shown for the material lines 34a, 34b, a single temperature control and temperature gauge could be used. Preferably, separate controls are provided because each spray component is likely to have a different preferred viscosity for spraying, and maintaining the preferred viscosity lowers the pumping power and pumping duty cycle. Preferably, the temperature controls and gauges are digital, but analog controls and gauges can be used, as could other controls and gauges.

The viscosity of the sprayed material will vary with the object sprayed and the material used. The resin 26 and activator 28 used to form truck bed linings are usually viscous materials, having a viscosity of over about 700 centipoise, and below about 2000 centipoise. A viscosity of about 750-2000 centipoise is desired, and the specific component materials 26, 28 that are used, as well as the temperature of the component materials 26, 28 will affect the viscosity. The pumps 32 and motor or motors 30 must be sized appropriately for the viscosity of the coating materials to be sprayed and the object to be sprayed.

Pumps 32 with a rating of 3 gallons per minute are believed suitable for use in spraying truck bed liners with the above material. These pumps 32 are used to pump the resin 26 and activator 28 from tanks 24a, 24b, to the spray gun 36. By placing both pumps 32 on a common shaft driven by a single motor 30, the pumps 32 can pump the plural component materials at the same rate. For the preferred system spraying truck bed liners, the pumps 32 are operated to pump about 0.1 to 0.15 gpm during use of the spray system, but the pumping requirements will vary, depending in part on the object sprayed and the material sprayed.

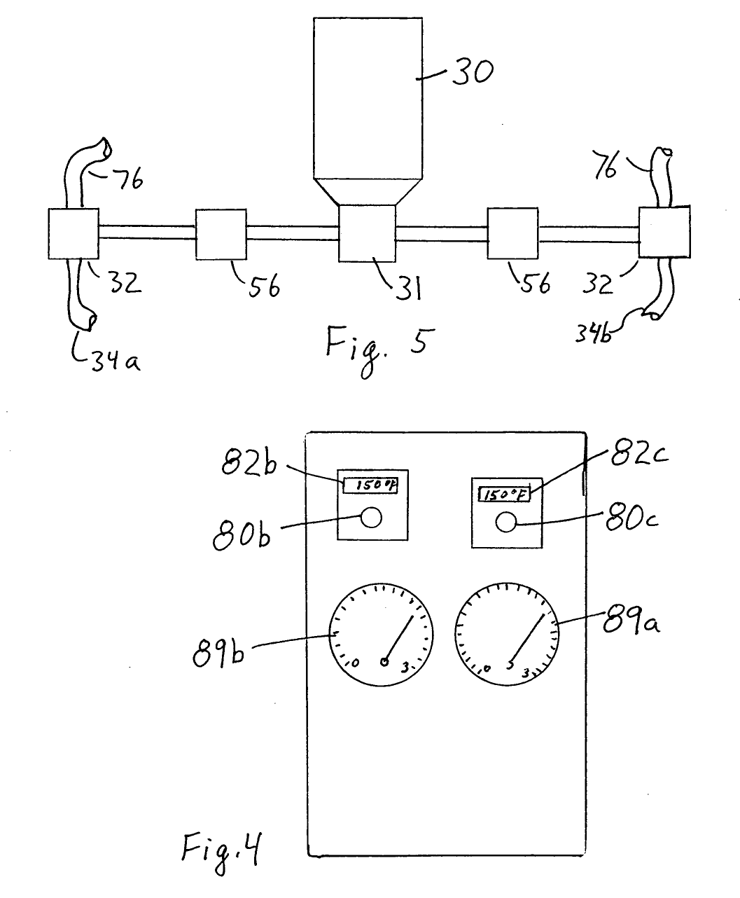

Referring to FIGS. 2 and 4, a fluid line 76 places each tank 24 in fluid communication with one of the pumps 32. Preferably, one end of fluid line 76 removably connects to a fitting on the bottom of a tank 24 so the tank can be removed and replaced if desired. The other end of each fluid line 76 is connected to one of the pumps 32. A ½ inch port on the tank, and the same sized tubing are believed suitable for the preferred embodiment. The pumps 32 and motor 30 are preferably enclosed within the cart 20 to maintain the temperature of the plural component materials, resin 26 and activator 28. But enclosing the pump 32 and motor 30 also allows the heat from the pump to be used to maintain the operating temperature of the cart 20 and spray materials enclosed within the cart.

The plural component materials, the resin 26 and the activator 28, are sensitive to moisture as well as being sensitive to temperature. As the level of material within each tank 24 lowers, air enters the tank and the air can contain sufficient moisture to affect the performance of the spraying and hardening of the materials. An airline is attached to each sealed tank and also connected to a desiccant filter that removes moisture from the air as the air passes through it to the tank. Alternatively, the desiccant filter can be removed, and the air line can have a distal end opening into the interior of the cart 20, because the heat inside the cart can drive out sufficient moisture to provide a source of air that is sufficiently moisture-free to avoid undesirable affects on the materials in the tanks 24.

Referring still to FIGS. 1-2, a pressure regulator 86 is used to regulate the pressure in the material line 34 so that the pressure in each material line 34 can be independently adjusted using pressure regulator 86. A pressure sensor, illustrated as a pressure gauge 88, monitors the pressure to make use of regulator 86 easier.

In the illustrated embodiment, each pump 32a, 32b pumps at a constant rate in order to use a low power for the pumps. The amount of material 26, 28 provided to spray gun 36 is regulated or varied by returning a portion of the pump output to the tanks 24. Each pump 32a, 32b has a return line 90a, 90b running from the downstream side of the pump 32 back to the respective tank 24a, 24b. The pressure regulator 86a, 86b is adjusted to vary the amount of material 26, 28 returned to the respective tank 24a, 24b, and that regulates the amount of material in the respective material lines 34a, 34b. The pressure gauge 88a, 88b indicates the pressure in the return line and also indicates the pressure in the associated material line 34a, 34b. The pressure gauges 88a, 88b could thus also be placed on the respective material lines 34a, 34b. By monitoring the pressure in the lines downstream of the pumps 32a, 32b using gauges 88a, 88b, and by adjusting the pressure regulators 86a, 86b, the pressure in the material lines 34a, 34b can be adjusted to a desired pressure for each line. Each line 34a, 34b is of a fixed cross-sectional area so by varying the pressure, the flow rate of material to the spray gun 36 can also be varied or adjusted.

Referring to FIGS. 1-2 and 4, the output of the pressure sensors are preferably visually displayed, as through pressure gauges 88a, 88b on an externally accessible control panel. Controls 89a, 89b allow adjustment of the regulators 86a, 86b. Running the controls 89a, 89b to an externally accessible control panel avoids having to open doors 60 in the cart to access the gauges 88 and regulators 86 to adjust the pressure in the material lines 34.

Gauges 88 and regulators 86 with an upper pressure range of about 3,000 psi are believed suitable for the illustrated embodiment suitable for spraying truck bed liners. The pressure regulators 86 are preferably, but optionally constructed with seals made of polytetrafluoroethylene (PFTE). The PFTE seals resist seal swelling which can require more power to operate the regulators 86. The PFTE seals are also more resistant to degradation from the materials likely to be used in the spray system, and thus maintain the operating pressures better and in turn require lower power to drive the pumps 32 as the regulators wear with use.

One or more gas tanks 38 are mounted to the cart. Preferably the bottom of the cart is extended to form a ledge and one or more air or nitrogen or other gas bottles 38 are set on the ledge. Preferably the bottles 38 are chained to the cart or otherwise secured so they do not fall over.

A flow rate of between about 11 to 15 cfm from the gas tank(s) 38 is thus desirable, at a pressure of about 150 psi is believed suitable for the illustrated embodiment suitable for spraying truck bed liners. The gas tank(s) 38 are capable of high pressures, exceeding 1000 psi. This may be viewed as a low flow rate, high pressure gas supply.

Alternatively, a high volume, low pressure compressor could be used as in the prior art, but such a compressor requires electrical power and is thus undesirable as it will likely make the use of a single 110V power source unusable, or it will require a combustion engine which is undesirable. By high volume, flow rates of 50-100 cfm. By low pressure, pressures of under about 20-25 psi are contemplated.

The motor 30 is placed inside the cart 20 to allow the heat from the motor to be used to maintain the temperature inside the cart. If the motor 30 generates, it can complicate the operational control of heater 22. Thus, it may be advantageous to place the motor 30 in a sub-compartment within the cart 20, and to insulate that sub-compartment. Moreover, it is believed possible, but not desirable, to have the motor 30 located outside of the heated portion of the cart 20.

This pressurized air from the gas tank(s) 38 is transferred to the spray gun 36 through airline 42. The spray gun 36 is preferably, but optionally a Graco Fusion Mechanical Purge Gun, which does not use the large volumes of air to operate as required by prior systems, such as that disclosed in U.S. Pat. No. 6,533,189. This previously patented gun uses compressed air to force the materials 26, 28 through the material lines 34a, 34b and through a mixing chamber in the spray gun 36. Alternatively, the prior art used compressed air to move the materials 26, 28 through the mixing chamber in the spray gun. Either mode of operation requires a large air compressor that uses a lot of power, and typically requires a 220V compressor. Neither of the prior systems is usable in the present spray system if it makes the total power requirements of the system exceed those available from a single 110 V line.

The preferred spray gun 36 preferably, but optionally, does not use gas or air to force the materials 26, 28 through the mixing chamber and through the spray gun and out the nozzle. Preferably, but optionally, the preferred spray gun 36 does not use uses gas or air to atomize the mixed materials 26, 28. Rather, the spray gun preferably uses gas or air to operate the gun, and uses a mechanical purge of the mixing chamber which pushes the mixed materials 26, 28 toward and/or out the spray tip 44 where the compressed gas from tank(s) 38 spray the material in the desired pattern or density. Pushing a rod through the mixing chamber can achieve this operation. This allows a start and stop operation of the spray gun 36 without clogging. A suitable spray gun is disclosed in U.S. Pat. No. 6,601,782, the complete contents of which are incorporated herein by reference.

To accommodate the gas volume, a ¼ inch diameter airline is preferred. Other sized lines can be used, but the smaller diameter is preferred because it is more easily maneuverable. The airline 42 is optionally but preferably removably connected to an outlet on the pressure, flow regulator 40 which are typically mounted to the gas tanks 38.84

Material lines 34a, 34b carry the resin 26 and activator 28 from the hydraulic pumps 32 to the special spray gun 36. Even though the pressure carried by these lines is low, the lines 34 are preferably a high strength line that reduces the radial expansion of the line under operating pressures. The lines 34 are preferably a made of a stiff material that does not expand radially under pressure. A line 34 having a Teflon tube with a flexible, stainless steel braid surrounding the Teflon for burst resistance is believed suitable. A burst pressure on these Teflon-steel braided material lines 34 of about 5,000 psi is desirable. The general operating pressure from the material pumps 32 is an aveage of about 1,200 psi so the pressure in the line 34 is less than about 10 times the burst strength of the line.

The airline 42 is preferably made of a flexible metal tubing intertwined with a cotton fiber in-between the joints to prevent air leakage in the metal joints.

When the spray system is not being used, the material lines 34 are disconnected from the spray gun 36 and connected to the tanks 34 by connectors on the tanks so that the materials 26, 28 can cycle through the lines periodically to eliminate material build up in the lines and to keep the material in suspension. A circulation of 10 minutes every 4 hours via an automatic timer that is tied to the pump motor 30 is believed suitable for the preferred embodiment. The appropriate time intervals will depend on the materials used, the insulation of the cart 20, the size of the heater and the environmental temperature.

If the connector is placed on the tank 34 external to the cart 20, then the tank can be readily disconnected and removed from the cart. The connection with the activator tank 24a is preferably, but optionally, provided internal to the cart 20. The activator 28 is more temperature sensitive so the internal location of the connector 86 helps maintain the temperature. Advantageously, the cart 20 has a shelf or sufficient space to allow the entire material line 34 to be placed inside the cart 20 when the spraying system is not in use. This allows the temperature of the entire line 34 to be maintained by the cart 20 and its temperature controlled interior via heater 22. The shelf or space to store the material lines 34 is advantageously accessible through a door 60.

The motor 30 is preferably a 110 volt, double stack, low-ramp DC motor (DSLR). The motor is preferably a 90V motor, about 1.7 hp, operating at about 2500 rpm. The output of motor 30 is through a rotating drive shaft which drives gearbox 31. A modular designed gear box is preferred, with a gear reduction of about 5:1 believed suitable, with an output speed of about 2500 rpm. Advantageously, but optionally, helicoid gears are used with fiberglass bushings on the gears and/or input and output shafts, to provide high capacity and high efficiency. Further, the gear shafts are optionally hollow, and larger than would be normal for a solid shaft gear system. The gear reduction 31 preferably uses synthetic lubricants to reduce temperature and to increase operating and service life. The output from gear reduction 31 is preferably through a large diameter shaft allowing a larger diameter bearing to accommodate increased torque from the motor 30 and gear reduction 31.

The 110 line input voltage passes through a drive inverter 50 and preferably that also uses a pulse width modulated (PWM) signal to reduce the operating current to the motor 30. The drive inverter 50 converts the 110 volt AC current into a DC current, and preferably, but optionally, into a square wave DC current. This is believed to improve efficiency and life of the motor 30. The DC current is applied to the motor 30 and to the heaters 35 on the material lines 34, however 110 V AC is directed to any heaters on the tanks 24. Preferably, but optionally, a variable speed control 51 is provided to vary the speed of the motor 30 by varying the voltage from the drive inverter 50 to the motor.

Preferably, the motor 30 is of modular construction and is coupled to the pumps 32 through couplers 56. The couplers 56 allow the motor 30, or either of the pumps 32, to be more easily removed. The pumps 32 are high efficiency, positive displacement pumps which do not loose pressure under extreme operating conditions. The viscosity of the resin 26 and activator 28 will vary, and the pumps have to work efficiently, with low power requirements.

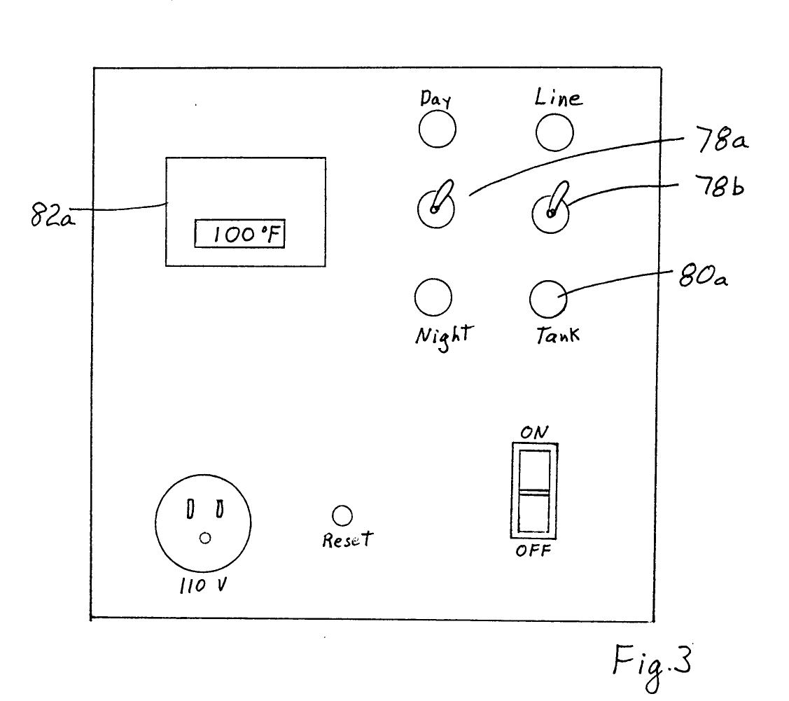

To use the system, the cart 20 is connected to a standard 110V power outlet. Materials 26, 28 are placed in the tanks 24, and the power is turned on using a master power switch (FIG. 3). The heaters 22a, 22b around the tanks 24 and any auxiliary heater 22 inside the cart 20 are activated and the desired temperatures set using the controls 80 (FIG. 2). When the temperature of materials 26, 28 reach a desired temperature (e.g., about 110° F.) as indicated by the sensors or by the displays 82, the heaters 35 on the material supply lines 34 are activated. Shortly before, or after activation of the line heaters 35, the material lines 34 are connected to the tanks 24 and the spray gun 36 is connected to the material lines and to the pressurized gas line 42. When the material 26, 28 is at a suitable temperature and suitably flowable, the pumps 32 are activated and adjusted as desired. A pressure of about 2000 psi is believed suitable for the illustrated embodiment of spraying truck bed liners. The regulators 40 on the gas supply are likewise adjusted until an acceptable spray pattern is produced by the spray gun 36. The desired object 54 is then sprayed to form coating 52.

After spraying is finished the power to the heaters 22 is turned off. The material lines 34 are disconnected from the spray gun 36, and the spray gun is cleaned. The pressurized gas line 42 may be left attached to the spray gun 36 or disconnected. The gas tank(s) 38 are optionally shut off. The ends of the material lines 34 that were connected to the spray gun 36 are connected to the tanks 24 so material can recirculate through the lines 34 and tanks 24. The system is switched to the night mode using switch 78b, which optionally lowers the temperature in the tanks 24 to a standby or overnight temperature that is optionally lower than the operating spraying temperature, and that periodically activates pumps 32 to recirculate material 26, 28 through the lines 34.

The spray system disclosed herein can operate on a standard 110V power outlet. The current drawn by the pump 32 and line heaters 35 is about 16 amps, which is believed to be well under half that used by the prior art. The double stack, DC motor provides high torque at low amperage, and is a small, 1.75 HP motor. This contrasts to the commercial embodiment of the system of U.S. Pat. No. 6,533,189 which uses 220V three phase outlets to power 10 hp compressor generating 11-15 cfm. The cart 20 of the present invention is sufficiently portable that it can fit into an elevator or through a doorway and be moved into position by a single person. The operational cart 20 is believed to weigh about 400 pounds, or less.

The above description is given by way of example, and not limitation. Given the above disclosure, one skilled in the art could devise variations that are within the scope and spirit of the invention, including various ways of using the present method and apparatus to coat various surfaces 52 other than truck bed liners. For example, concrete surfaces or surfaces on the inside or outside of buildings could be coated with the method and apparatus of this invention. Other surfaces, preferably, but optionally, hard surfaces, can be coated for the purpose of waterproofing and abrasion or impact resistance using the resins involved here. Further, the various features of this invention can be used alone, or in varying combinations with each other and are not intended to be limited to the specific combination described herein. Thus, the invention is not to be limited by the illustrated embodiments but is to be defined by the following claims when read in the broadest reasonable manner to preserve the validity of the claims.

What is claimed is:

1. A portable system for spraying viscous coating material having a viscosity of about 700-2000 centipoise, comprising:
a portable cart having an enclosed interior;
at least two containers for holding at least two coating materials during use of the system, the containers having a major portion enclosed within the interior of the cart;
a converter converting a single 110 volt AC input into direct current;
a resistance heater in conductive thermal communication with the at least two containers and powered by the converter;
at least one gas tank mounted on the cart;
first and second material transfer lines each having a first end adapted to be placed in fluid communication with a different one of the containers, each material transfer line having a second end;
a resistance heater in conductive thermal communication with each of the first and second material lines and powered by the converter;
a gas line having a first end in fluid communication with the gas tank and having a second end;
A spray gun for spraying the coating material, the spray gun being in fluid: communication with the second ends of the first and second material transfer lines and in fluid communication with the second end of the gas line, the spray gun having a positive displacement mixer having an inlet in fluid communication with the second end of the material transfer lines and having an output in fluid communication with a nozzle, the nozzle being in fluid communication with the second end of the gas line;
a direct current motor driving first and second pumps through a gearbox with a thru shaft, the first pump being in fluid communication with the first container and driving communication with the second pump being in fluid communication with the second container and being in driving communication with the gear box and powered by the converter.

2. The portable spray system of claim 1, wherein the converter converts 110 volt AC to a square wave, direct current, and further comprising a pulse width modulated signal to power the motor.

3. The portable spray system of claim 1, wherein the motor comprises a double stack, low ramp, DC motor.

4. The portable spray system of claim 1, wherein each container and the material lines have a separate, variable electric temperature control.

5. The portable spray system of claim 1, wherein the first pump is in fluid communication with a first pressure regulator which recirculates material from the first container to control the pressure in the first material line.

6. The portable spray system of claim 1, wherein the first pump is in fluid communication with a first pressure regulator which recirculates material from the first container to control the pressure in the first material line, and wherein the second first pump is in fluid communication with a second pressure regulator which recirculates material from the second container to control the pressure in the first material line.

7. The portable spray system of claim 5, wherein the air tank has a pressure regulator.

8. The portable spray system of claim 6, wherein the air tank has a pressure regulator.

9. The portable spray system of claim 1, further comprising a radiant heater located in the interior of the cart.

10. A portable system for spraying viscous coating material having a viscosity of about 700-2000 centipoise, comprising:
a portable cart having an enclosed interior;
at least two containers for holding at least two coating materials during use of the system, the containers having a major portion enclosed within the interior of the cart;
a source of gas at a pressure of under about 1000 psi and under about 10 cfm;
first and second material transfer lines each having a first end adapted to be placed in fluid communication with a different one of the containers, each material transfer line having a second end;
a gas line having a first end in fluid communication with the gas source and having a second end;
a spray gun for spraying the coating material and in fluid communication with the second ends of the first and second material transfer lines and in fluid communication with the second end of the gas line, the spray gun having a positive displacement mixer having an inlet in fluid communication with the second end of the material transfer lines and having an output in fluid communication with a nozzle, the spray gun being in fluid communication with the second end of the gas line;
means for moving coating material from the first and second containers, through the material lines to the spray gun during spraying;
heating means for heating the first and second containers and said first and second material lines during spraying, said means for moving and said heating means operating on a single 110 volt AC line.

11. The portable system of claim 10, wherein the source of gas comprises a tank of pressurized gas with a pressure regulator.

12. A portable system for spraying viscous coating material having a viscosity of about 700-2000 centipoise, comprising:
a portable cart having wheels and an enclosed interior and sufficiently small to be moved by one person;
at least two containers for holding at least two coating materials during use of the system;
a first resistance heater in conductive thermal communication with the at least two containers;
at least one gas source mounted on the cart and a pressure regulator on the output of the gas source;
first and second heated material transfer lines each having a first end adapted to be placed in fluid communication with a different one of the containers, each material transfer line having a second end;
a second resistance heater in conductive thermal communication with each of the first and second material lines;
a gas line having a first end in fluid communication with the gas tank and having a second end;
a spray gun for spraying the coating material and placed in fluid communication with the second ends of the first and second material transfer lines and in fluid communication with the second end of the gas line, the spray gun having a positive displacement mixer having an inlet in fluid communication with the second end of the first and second material transfer lines and having a nozzle, the spray gun being in further fluid communication with the second end of the gas line;
a direct current motor driving first and second pumps through a gear box, the first pump being in fluid communication with the first container and the second pump being in fluid communication with the second container to pump material from the containers through the heated material transfer lines to the spray gun; and
a converter converting a single 110 volt AC input into direct current, and placed in electrical communication with the direct current motor.

13. The system of claim 12, wherein the motor comprises a double stack, low-ramp motor.

14. The system of claim 13, wherein the motor drives each pump through a separate gear box containing helicoidal gears.

15. The system of claim 13, wherein the motor is powered by a pulse width modulated signal.

16. The system of claim 13, wherein the gas source comprises a tank of pressurized gas with a pressure regulator.

17. The system of claim 16, wherein the first pump has a first recirculation line in fluid communication with the first container and a first pressure regulator diverting the material from the first material line to the first recirculation line to regulate pressure in the first fluid line.

18. The system of claim 17, wherein the second pump has a second recirculation line in fluid communication with the second container and a second pressure regulator diverting the material from the second material line to the second recirculation line to regulate pressure in the second fluid line.

19. The system of claim 17, wherein the first container contains an activator and the second container contains a resin.

20. The system of claim 17, further comprising an auxiliary heater inside the cart and powered by the converter.
